(19) United States
(12) Patent Application Publication
(10) Pub. No.: US 2016/0134967 A1
(43) Pub. Date: May 12, 2016

(54) BIASING CIRCUIT FOR MICROPHONE AND MICROPHONE INCLUDING THE SAME

(71) Applicant: HYUNDAI MOTOR COMPANY, Seoul (KR)

(72) Inventor: Soon Myung KWON, Hwaseong-si (KR)

(73) Assignee: HYUNDAI MOTOR COMPANY

(21) Appl. No.: 14/813,511

(22) Filed: Jul. 30, 2015

(30) Foreign Application Priority Data
Nov. 11, 2014 (KR) 10-2014-0156429

(51) Int. Cl. H04R 3/00; H04R 19/04; H04R 19/00

(52) U.S. Cl. CPC H04R 3/00; H04R 19/005; H04R 19/04

(57) ABSTRACT

A microphone in accordance with an exemplary embodiment of the present invention includes a biasing circuit to provide a variable bias voltage to a sensor. The biasing circuit includes: a regulator which receives a reference voltage and a control voltage to output a variable voltage; a digital to analog converter which receives a digital control signal to provide the control voltage to the regulator; and a charge pump which receives the variable voltage output from the regulator to output a variable voltage that is higher than the variable voltage.

### CROSS-REFERENCE TO RELATED APPLICATION

This application claims priority to and the benefit of Korean Patent Application No. 10-2014-0156429 filed in the Korean Intellectual Property Office on Nov. 11, 2014, the entire contents of which are incorporated herein by reference.

### BACKGROUND OF THE INVENTION

(a) Field of the Invention

The present invention relates to a microphone, and more particularly to a biasing circuit of the microphone.

(b) Description of the Related Art

A microphone used in a mobile device, an audio device, a vehicle, or the like converts a sound, that is, a sound wave, into an electrical signal. The microphone is gradually being downsized. Accordingly, a microphone using a microelectromechanical system (MEMS) technology is being developed.

Such a MEMS microphone is advantageous in that it is more resistant to humidity and heat compared to a conventional electret condenser microphone (ECM), and it may be downsized and integrated with a signal processing circuit.

The MEMS microphone includes a sensor which senses a sound wave to generate an electrical signal. The sensor is formed through a semiconductor process, and sensitivity of the sensor is deviated according to deviation of a process size. Then sensitivity of the microphone is determined by a biasing circuit connected to the sensor to provide a fixed bias voltage and a variable gain amplifier (VGA). In general, the sensitivity of the microphone is determined using the process deviation of the sensor and the VGA.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a biasing circuit for a microphone and a microphone including the same having advantages of increasing a margin of process deviation of a sensor in the microphone.

An exemplary embodiment of the present invention provides a biasing circuit for providing a variable bias voltage to a sensor of a microphone

The biasing circuit includes: a regulator which receives a reference voltage and a control voltage to output a variable voltage; a digital to analog converter which converts a received digital control signal to the control voltage transmitted to the regulator; and a charge pump which receives the variable voltage output from the regulator to correspondingly output a variable voltage that is higher than the variable voltage.

The biasing circuit may further include: an oscillator to generate a pulse signal; and a level shifter which receives the pulse signal from the oscillator and the variable voltage from the regulator, and adjusts the pulse signal to a level of the variable voltage to provide the adjusted pulse signal to the charge pump.

The digital control signal may include an 8-bit signal.

The regulator may include a low-dropout (LDO) regulator.

The charge pump may include a voltage tripler.

A microphone in accordance with an exemplary embodiment of the present invention includes a sensor and a biasing circuit to provide a variable bias voltage to the sensor. The biasing circuit includes: a low-dropout (LDO) regulator which receives a reference voltage and a control voltage to output a variable voltage; a digital to analog converter converts a received digital control signal to the control voltage transmitted to the LDO regulator; an oscillator to generate a pulse signal; a level shifter which receives the pulse signal from the oscillator and the variable voltage from the regulator, and adjusts the pulse signal to a level of the variable voltage to output the adjusted pulse signal; and a charge pump which receives the variable voltage output from the regulator and the adjusted pulse signal output from the level shifter to output a variable voltage that is higher than the variable voltage.

The sensor may include a vibration membrane and a fixed electrode which have characteristics of a capacitor.

The digital control signal may include an 8-bit signal.

The variable bias voltage may be in a range of about 4.5 V to about 13.5 V.

Due to the biasing circuit according to the present invention, a variable range of a VGA may be reduced and it is possible to cope with sensitivity deviation of a sensor. Particularly, a margin with respect to process deviation of the sensor may be increased. Accordingly, a process yield ratio of the sensor is increased so that a manufacturing cost of the microphone may be reduced.

### BRIEF DESCRIPTION OF THE DRAWINGS

FIG. 1 is a schematic cross-sectional view of a microphone in accordance with an exemplary embodiment of the present invention;

FIG. 2 is a block diagram illustrating a biasing circuit according to an exemplary embodiment of the present invention; and

FIG. 3 is a graph illustrating a simulation result of the biasing circuit exemplary embodiment shown in FIG. 2.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. In addition, unless explicitly described to the contrary, the word “comprise” and variations such as “comprises” or “comprising” will be understood to imply the inclusion of stated elements but not the exclusion of any other elements.

Hereinafter, a biasing circuit for a microphone in accordance with an exemplary embodiment of the present invention will be described in detail with reference to the accompanying drawings. The biasing circuit for a microphone may simply be referred to as a biasing circuit.

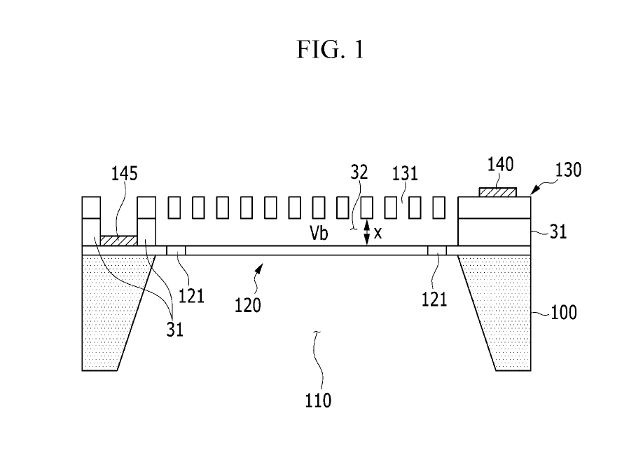

FIG. 1 is a schematic cross-sectional view of a microphone in accordance with an exemplary embodiment of the present invention.

Referring to FIG. 1, the microphone includes a substrate 100, a vibration membrane 120, and a fixed electrode 130. The vibration membrane 120 and the fixed electrode 130 constitute a sensor which senses a sound wave to generate an electric signal according to the sound wave.

The substrate 100 may be made of silicon, and a penetration hole 110 is formed in the substrate 100.

The vibration membrane 120 is disposed on the substrate 100. The vibration membrane 120 covers the penetration hole 110. Part of the vibration membrane 120 is exposed to the penetration hole 110, and part of the vibration membrane 120 exposed to the penetration hole 110 is vibrated in response to an external sound. The vibration membrane 120 may be made of polysilicon or conductive materials. The vibration membrane 120 may have a circular shape

The vibration membrane 120 may be vibratably fixed to the substrate 100 through a spring 121 which is formed at an edge of the vibration membrane 120.

The fixed electrode 130 spaced apart from the vibration membrane 120 is disposed on the vibration membrane 120. The fixed electrode 130 includes a plurality of air inlets 131.

The fixed electrode 130 is disposed on a support layer 31. The support layer 31 is disposed at an edge part of the vibration membrane 120, and it supports the fixed electrode 130. In this case, the fixed electrode 130 may be made of polysilicon or a metal.

An air layer 32 is formed between the fixed electrode 130 and the vibration membrane 120. The fixed electrode 130 and the vibration membrane 120 are spaced apart from each other by a predetermined interval x.

An external sound is introduced through the air inlets 131 formed in the fixed electrode 130, thus stimulating the vibration membrane 120. In response thereto, the vibration membrane 120 is vibrated.

The vibration membrane 120 and the fixed electrode 130 constituting the sensor of the microphone have characteristics of a capacitor. When an external sound pressure according to a sound wave is applied to the vibration membrane 120, a capacitance value is changed because the vibration membrane 120 is vibrated so that the distance between the vibration membrane 120 and the fixed electrode 130 is changed. Accordingly, the sound wave is converted into capacitive variations by the sensor of the microphone. For example, the capacitive variations are input to a signal processing circuit (not shown) through a first pad 140 connected to the fixed electrode 130 and a second pad 145 connected to the vibration membrane 120, and may be processed for various purposes by the signal processing circuit.

In order to operate the sensor, a bias voltage V_{b} should be applied between the vibration membrane 120 and the fixed electrode 130 of the sensor. A circuit for applying the bias voltage V_{b} to the sensor is referred to as a biasing circuit (not shown). The biasing circuit is mounted in one chip together with the signal processing circuit and the like to configure an application specific integrated circuit (ASIC).

Sensitivity ΔV of the sensor is defined by a following equation.

$$Δ V = \frac{{C}_{0} {V}_{b} Δ x}{{ɛ}_{ 0} A} = - \frac{Δ x}{{x}_{0}} {V}_{b}$$

$$Δ V = - \frac{Δ x}{{x}_{0}} {V}_{b} = - \frac{{V}_{b}}{{x}_{0}} \frac{Δ PA}{{k}_{m}} ∝ - \frac{Δ PA}{{x}_{0}} \frac{{I}^{3}}{{wt}^{3}} \times {V}_{b}$$

In the above equation, C₀ represents initial capacitance in a state in which sound pressure is not applied, V_{b} represents a bias voltage provided between the vibration membrane and the fixed electrode, ε₀ represents permittivity of air, A represents an effective area of the capacitor, P represents sound pressure, kₘ represents a spring constant, l represents a length of the spring, w represents a width of the spring, and t represents a thickness of the spring.

Accordingly, the sensitivity ΔV of the sensor is inversely proportional to an initial interval x₀ between the fixed membrane 120 and the vibration membrane 130, and is proportional to an interval variation amount Δx with respect to the sound pressure. In other words, in order to obtain a constant ratio ΔV/ΔP of sensitivity of the sensor to the sound pressure, the width w of the spring, the length l of the spring, the thickness t of the spring, the initial interval x₀, and the like should be constant. However, the above values are changed due to process deviation.

In a general structure of the microphone, assuming that an error of a process (e.g., deposition such as chemical vapor deposition (CVD)) of determining the thickness t of the spring is ±10%, and an error of a process (e.g., lithography) of determining the length l and the width w of the spring is ±5%, the sensitivity of the sensor has a deviation range of about 0.56 ΔV to about 1.86 ΔV of the initial value from the above equation.

If the sensitivity of the sensor has the range of about 0.56 ΔV to about 1.86 ΔV, a bias voltage V_{b} for receiving the above sensitivity deviation may have the range of about 0.54 V_{b} to about 1.79 V_{b}. In other words, the same sensitivity may be obtained by applying the bias voltage Vb having the above range corresponding to the process deviation. In general, since the bias voltage V_{b} is designed to have a fixed voltage of about 8 V, if a biasing circuit for outputting, for example, a voltage in the range of about 4.5 V to about 13.5 V is configured in a match therewith, the process deviation of the sensor may be compensated by the biasing circuit.

Hereinafter, a variable biasing circuit capable of outputting a voltage changed through the above range will be described.

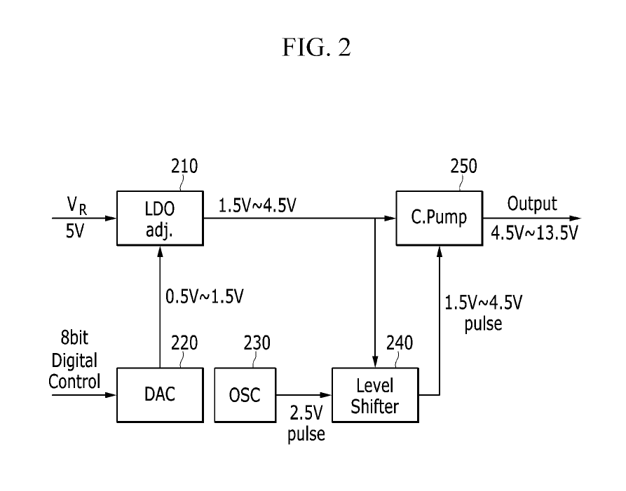

FIG. 2 is a block diagram illustrating a biasing circuit according to an exemplary embodiment of the present invention.

The biasing circuit includes a low-dropout (LDO) regulator 210, a digital to analog converter (DAC) 220, an oscillator 230, a level shifter 240, and a charge pump 250.

Basically, the biasing circuit outputs a voltage which is changed according to a digital control signal. The biasing circuit includes a variable voltage output circuit configured to determine a degree of the change according to the digital control signal, and to output a voltage in a predetermined range through an analog circuit.

As shown in FIG. 2, the biasing circuit may be designed to receive a reference voltage V_{R} of about 5 V and to output a voltage in the range of about 4.5 V to about 13.5 V according to the digital control signal. However, the range of the voltage is illustrative purpose only. The range of the output voltage may be changed according to a size of an input reference voltage V_{R} or characteristics of the biasing circuit.

The LDO regulator 210 receives an external reference voltage V_{R} to output a voltage in a predetermined range. For example, the LDO regulator 210 may be designed to receive a voltage of about 5 V and to output a voltage of about 1.5 V to about 4.5 V. A size of the output voltage of the LDO regulator 210 may be regulated according to a control voltage input from the DAC 220. Although the LDO regulator is illustrative by way of example, a regulator may be used for the biasing circuit in accordance with an exemplary embodiment of the present invention if the regulator receives a fixed voltage to output a variable voltage in the predetermined range.

The DAC 220 converts an external input digital control signal into an analog signal to output the analog signal, and the output analog signal is applied to the LOD regulator 210 as a control voltage. For example, the DAC 220 may be designed to convert an 8-bit digital control signal into a voltage of about 0.5 V to about 1.5 V. For example, the digital control signal may be input from a control circuit (not shown) of the microphone. Although the 8-bit signal is illustrated as the digital control signal by way of example, a smaller signal such as a 4-bit signal or a greater signal such as a 16-bit signal may be used.

Since 8 bits have 256 levels (i.e., 0 to 255), a voltage output from the DAC 220 may have 256 voltage levels in the range of about 0.5 V to about 1.5 V. For example, the about 0.5 V corresponds to a 0 level, the about 1.5 V corresponds to a 255 level, and about 1.0 V corresponds to a 128 level. Accordingly, in the illustrative numeral range, if a digital control signal at the 0 level is input to the DAC 220, a voltage of about 0.5 V is output so that a control voltage is applied to the LDO regulator 210, and the LDO regulator 210 may output a voltage of about 1.5 V. If a digital control signal at the 255 level is input to the DAC 220, a voltage of about 1.5 V is output so that the control voltage is applied to the LDO regulator 210, and the LDO regulator 210 may output a voltage of about 4.5 V. Further, if a digital control signal at the 255 level is input to the DAC 220, a voltage of about 1.5 V is output so that the control voltage is applied to the LDO regulator 210, and the LDO regulator 210 may output a voltage of about 4.5 V.

The voltage output from the LDO regulator 210 is provided to the level shifter 240 and the charge pump 250.

The level shifter 240 receives a signal from the oscillator 230 to control a level of the received signal. For example, the level shifter 240 may receive a pulse signal of about 1 MHz and 2.5 V from the oscillator 230. The level shifter 240 controls a level of a signal received from the oscillator 230 to a voltage level received from the LDO regulator 210 to output the controlled signal. Accordingly, in the illustrated range, the level shifter 240 may output a pulse in the range of about 1.5 V to about 4.5 V. The output pulse of the level shifter 240 may be filtered in order to reduce a noise such as a harmonic wave. The output pulse is provided to the charge pump 250.

The charge pump 250 is operated according to the pulse provided from the level shifter 240, and is driven according to a voltage provided from the LDO regulator 210. In response to an input pulse, the charge pump 250 may output a pumped voltage exceeding the input voltage. When the charge pump 250 is designed as a voltage tripler, if an input voltage is in the range of about 1.5 V to about 4.5 V, an output voltage is in the range of about 4.5 V to about 13.5 V.

The voltage output from the charge pump 250 may be a final output voltage of the biasing circuit, and this may be applied to the sensor of the microphone as a bias voltage V_{b}.

As described above, the output voltage of the biasing circuit may be controlled corresponding to the process deviation of the sensor according to the digital control signal. Accordingly, although the sensitivity of the sensor is deviated according to the process deviation of the sensor, the microphone may have predetermined sensitivity by suitably controlling the output voltage of the biasing circuit.

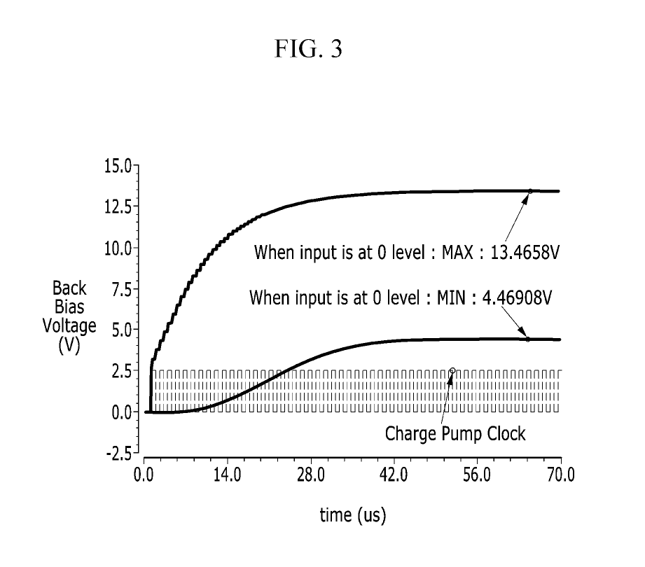

FIG. 3 is a graph illustrating a simulation result of the biasing circuit exemplary embodiment shown in FIG. 2.

A simulation represents voltages output when a control signal at a 0 level and a control signal at a 255 level are input while applying a reference voltage of 5 V to the biasing circuit, respectively. When the control signal at the 0 level is input, the output voltage is about 4.47 V. When the control signal at the 255 level is input, the output voltage is about 13.47 V. Accordingly, an operation of the biasing circuit that is capable of changing an output in the range of 0 to 255 levels through an input of 8 bits may be confirmed.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A biasing circuit for providing a variable bias voltage to a sensor of a microphone, the biasing circuit comprising:
a regulator receiving a reference voltage and a control voltage and outputting a variable voltage corresponding to the received control voltage;
a digital to analog converter converting a received digital control signal to the control voltage transmitted to the regulator; and
a charge pump receiving the variable voltage output from the regulator and correspondingly outputting a variable voltage that is higher than the variable voltage.

2. The biasing circuit of claim 1, further comprising:
an oscillator generating a pulse signal; and
a level shifter receiving the pulse signal from the oscillator and the variable voltage from the regulator, and adjusting the pulse signal to a level of the variable voltage to provide the adjusted pulse signal to the charge pump.

3. The biasing circuit of claim 2, wherein the digital control signal comprises an 8-bit signal.

4. The biasing circuit of claim 2, wherein the regulator comprises a low-dropout (LDO) regulator.

5. The biasing circuit of claim 2, wherein the charge pump comprises a voltage tripler.

6. A microphone comprising:
a sensor; and
a biasing circuit to provide a variable bias voltage to the sensor,
wherein the biasing circuit comprises:
a low-dropout (LDO) regulator receiving a reference voltage and a control voltage and outputting a variable voltage corresponding to the received control voltage;
a digital to analog converter converts a received digital control signal to the control voltage transmitted to the LDO regulator;
an oscillator generating a pulse signal;
a level shifter receiving the pulse signal from the oscillator and the variable voltage from the regulator, and adjusting the pulse signal to a level of the variable voltage to output the adjusted pulse signal; and
a charge pump receiving the variable voltage output from the regulator and the adjusted pulse signal output from the level shifter and correspondingly outputting a variable voltage that is higher than the variable voltage.

7. The microphone of claim 6, wherein the sensor comprises a vibration membrane and a fixed electrode which have characteristics of a capacitor.

8. The microphone of claim 6, wherein the digital control signal comprises an 8-bit signal.

9. The microphone of claim 6, wherein the variable bias voltage is in a range of about 4.5 V to about 13.5 V.
